(19) United States
(12) Patent Application Publication
(10) Pub. No.: US 2018/0080509 A1
(43) Pub. Date: Mar. 22, 2018

(54) ASYMMETRIC WEDGE CLUTCH

(71) Applicant: Schaeffler Technologies AG & Co. KG, Herzogenaurach (DE)

(72) Inventors: Brian Lee, York, SC (US); Carsten Ohr, Charlotte, NC (US)

(73) Assignee: Schaeffler Technologies AG & Co. KG, Herzogenaurach (DE)

(21) Appl. No.: 15/272,920

(22) Filed: Sep. 22, 2016

(51) Int. Cl. F16D 41/063; F16D 15/00

(52) U.S. Cl. CPC F16D 41/063; F16D 2023/123; F16D 15/00

(57) ABSTRACT

A bi-direction wedge clutch, including an axis of rotation, a wedge plate, and an inner race located radially inward of the wedge plate. The wedge plate includes: a first ramp extending progressively radially outward in a first circumferential direction and extending a distance in the first circumferential direction; and a second ramp directly connected to the first ramp, extending progressively radially outward in a second circumferential direction, opposite the first circumferential direction, and extending, in the first circumferential direction, a distance less than the distance for the first ramp. The inner race includes first and second ramps in contact with the first ramp of the wedge plate and the second ramp of the wedge plate, respectively.

### TECHNICAL FIELD

The present disclosure relates to a bi-directional asymmetric wedge clutch, in particular a bi-directional wedge clutch having asymmetric ramps on the inner race and wedge plate. Ramp pairs for the inner race have ramps with different circumferential extents and ramp pairs for the wedge plate have ramps with different circumferential extents.

### BACKGROUND

For some clutch applications, the duty cycle is such that the driving torque for a drive mode (for example, associated with rotation of an inner race in one circumferential direction) is significantly greater than the driven torque for a coast mode (for example, associated with rotation of the inner race in an opposite circumferential direction). The torque bearing capacity for each mode is related to the circumferential extent of the ramps on the wedge plate(s), with increasing circumferential extent resulting in increasing torque bearing capacity. For example, increasing the circumferential extent of the ramps increases the amount of stress the wedge plate can withstand under torque loading. Known bi-direction wedge clutches are symmetrically arranged so that the torque bearing capacity for the drive and coast modes are equal. This arrangement can result in too low a torque bearing capacity for the drive mode and an unnecessarily high torque bearing capacity for the coast mode.

The diameter or thickness of the wedge plate can be increased to increase torque bearing capacity for the clutch, but the trend in drive train design is to reduce component size and weight. Further, these modification would result in an increase in manufacturing costs. Increasing the number of wedge plates to increase torque bearing capacity has disadvantages related to increased size, weight, and cost.

### SUMMARY

According to aspects illustrated herein, there is provided a bi-direction wedge clutch, including an axis of rotation, an inner race, and a wedge plate located radially outward of the inner race. The inner race includes: first ramp extending progressively radially inward in a first circumferential direction and extending a distance in the first circumferential direction; and a second ramp directly connected to the first ramp, extending progressively radially inward in a second circumferential direction, opposite the first circumferential direction, and extending, in the first circumferential direction, a distance less than the distance for the first ramp. The wedge plate includes first and second ramps in contact with the first and second ramps, respectively, of the inner race.

According to aspects illustrated herein, there is provided a bi-direction wedge clutch, including an axis of rotation, a wedge plate, and an inner race located radially inward of the wedge plate. The wedge plate includes: a first ramp extending progressively radially outward in a first circumferential direction and extending a distance in the first circumferential direction; and a second ramp connected to the first ramp, extending progressively radially outward in a second circumferential direction, opposite the first circumferential direction, and extending, in the first circumferential direction, a distance less than the distance for the first ramp. The inner race includes first and second ramps in contact with the first ramp of the wedge plate and the second ramp of the wedge plate, respectively.

According to aspects illustrated herein, there is provided a bi-direction wedge clutch, including: an inner race; and a wedge plate located radially outward of the inner race. The inner race includes first and second pluralities of ramps. Each ramp in the first plurality of ramps: extends progressively radially inward in a first circumferential direction; and extends a distance in the first circumferential direction. The second plurality of ramps alternates, in the first circumferential direction, with the first plurality of ramps. Each ramp in the second plurality of ramps: extends progressively radially inward in a second circumferential direction, opposite the first circumferential direction; and extends, in the first circumferential direction, a distance less than the distance for said each ramp in the first plurality of ramps. The wedge plate includes a first plurality of ramps in contact with the first plurality of ramps of the wedge plate. Each ramp in the first plurality of ramps of the wedge plate: extends progressively radially inward in the first circumferential direction; and extends, in the first circumferential direction, a distance. The wedge plate includes a second plurality of ramps in contact with the second plurality of ramps for the inner race. Each ramp in the second plurality of ramps of the wedge plate: extends progressively radially inward in the second circumferential direction; and extends, in the first circumferential direction, a distance less than the distance for said each ramp in the first plurality of ramps of the wedge plate.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a cylindrical coordinate system demonstrating spatial terminology used in the present application;

FIG. 2 is a front view of a bi-directional asymmetric wedge clutch;

FIG. 3 is a front view of the inner race shown in FIG. 2;

FIG. 4 is a front view of the wedge plate shown in FIG. 2; and,

FIG. 5 is a front view of the wedge plate in FIG. 2, showing torque stresses.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

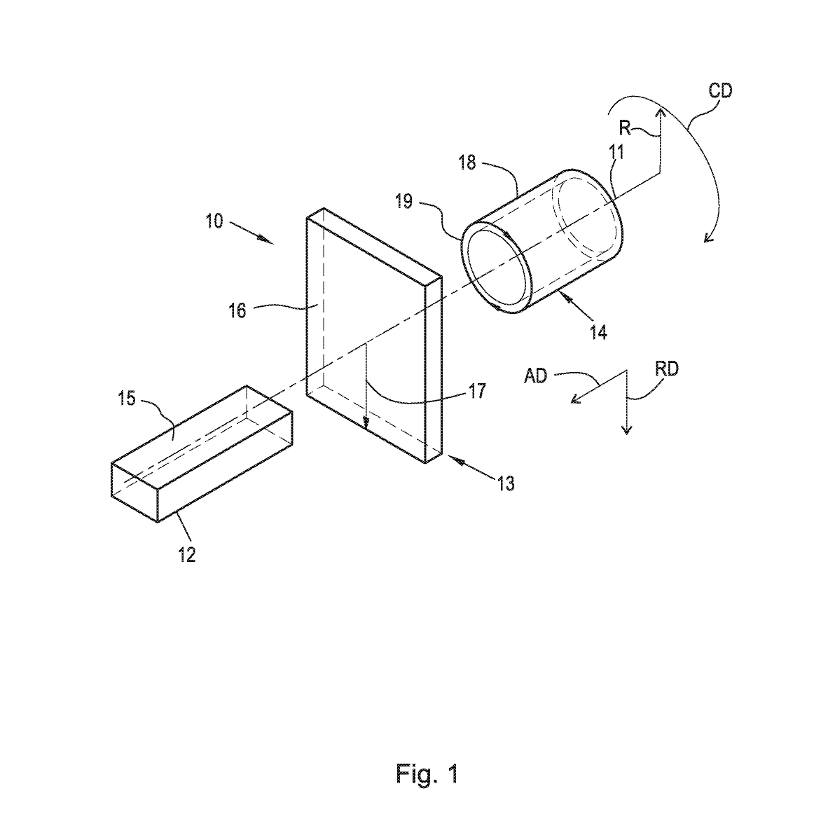

FIG. 1 is a perspective view of cylindrical coordinate system 10 demonstrating spatial terminology used in the present application. The present application is at least partially described within the context of a cylindrical coordinate system. System 10 includes longitudinal axis 11, used as the reference for the directional and spatial terms that follow. Axial direction AD is parallel to axis 11. Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane co-planar with axis 11. Axis 11 passes through planar surface 15; however any planar surface co-planar with axis 11 is an axial surface. A radial surface, such as surface 16 of object 13, is formed by a plane orthogonal to axis 11 and co-planar with a radius, for example, radius 17. Radius 17 passes through planar surface 16; however any planar surface co-planar with radius 17 is a radial surface. Surface 18 of object 14 forms a circumferential, or cylindrical, surface. For example, circumference 19 is passes through surface 18. As a further example, axial movement is parallel to axis 11, radial movement is orthogonal to axis 11, and circumferential movement is parallel to circumference 19. Rotational movement is with respect to axis 11. The adverbs “axially,” “radially,” and “circumferentially” refer to orientations parallel to axis 11, radius 17, and circumference 19, respectively. For example, an axially disposed surface or edge extends in direction AD, a radially disposed surface or edge extends in direction R, and a circumferentially disposed surface or edge extends in direction CD.

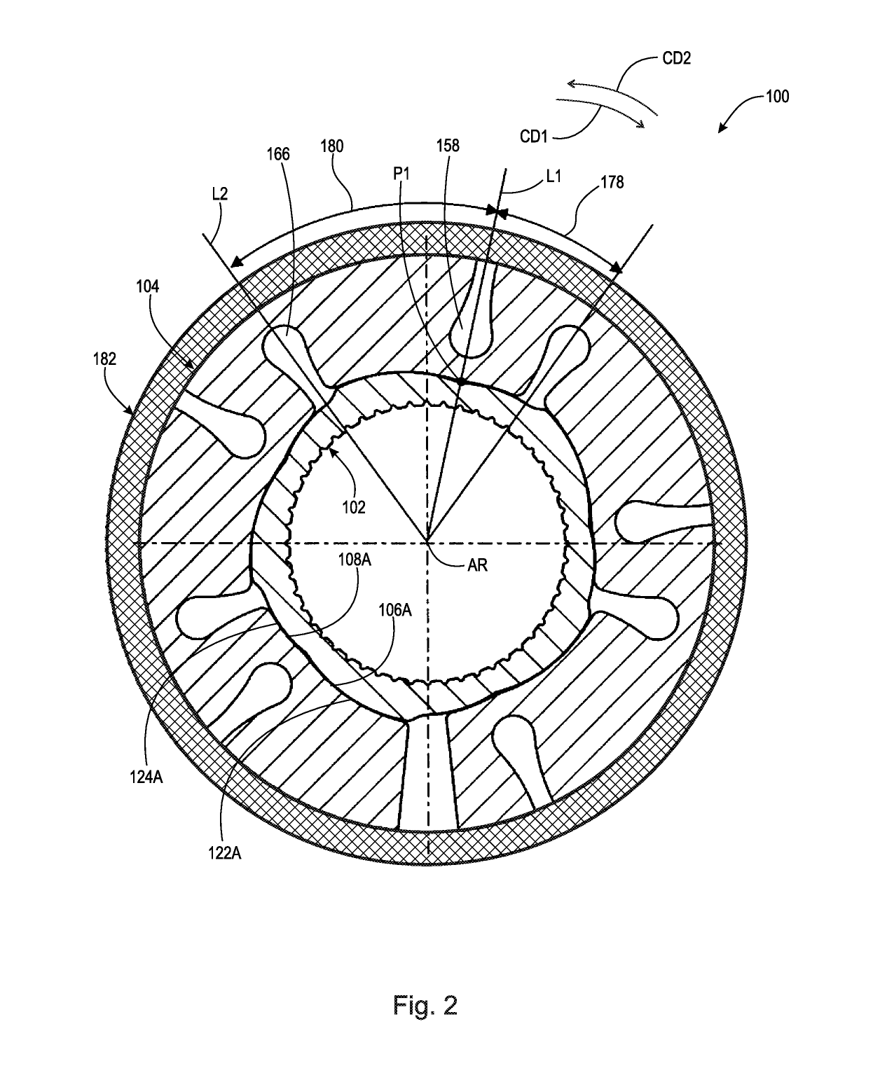

FIG. 2 is a front view of bi-directional asymmetric wedge clutch 100.

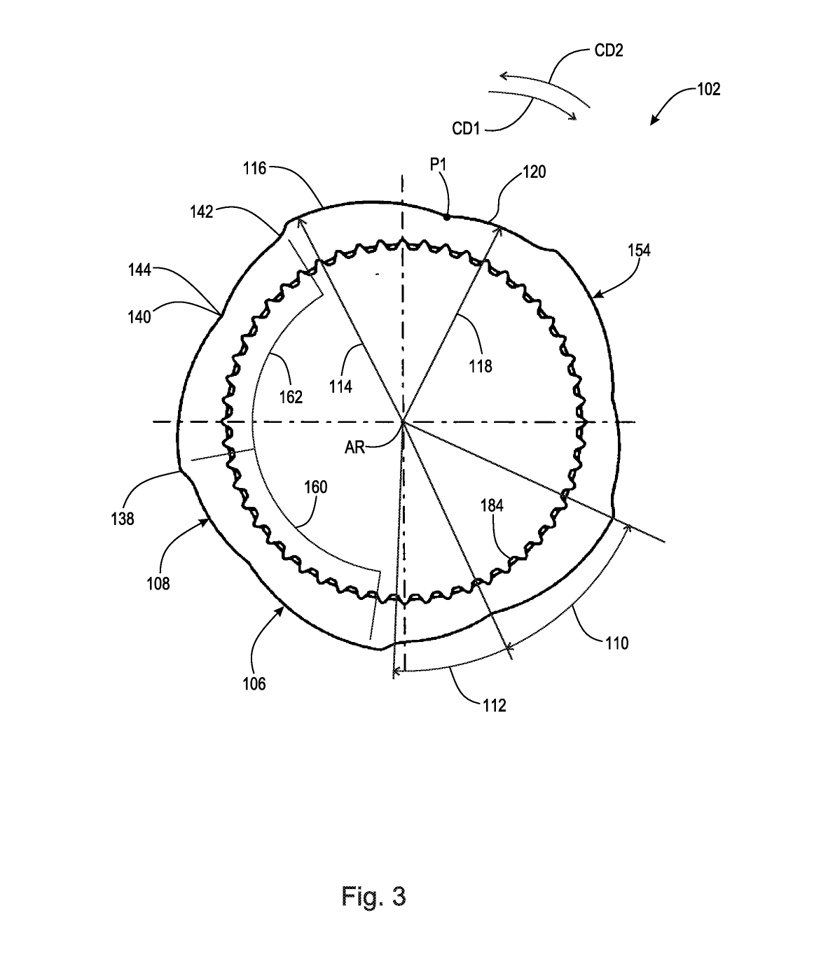

FIG. 3 is a front view of the inner race shown in FIG. 2.

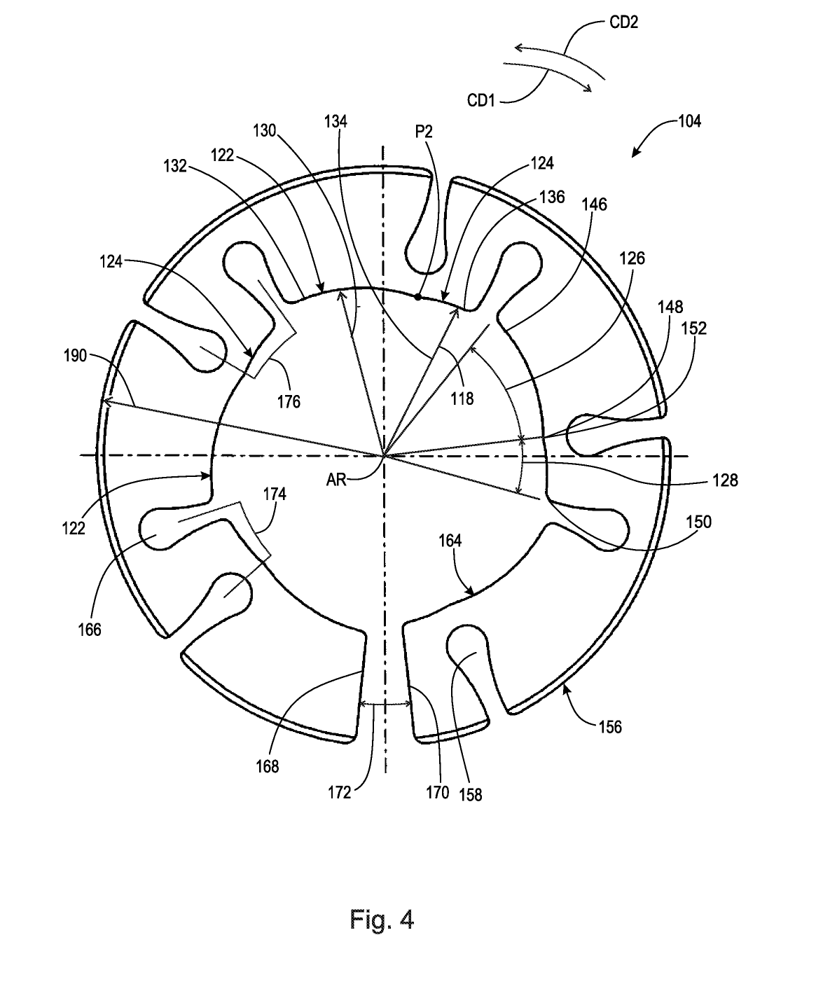

FIG. 4 is a front view of the wedge plate shown in FIG. 2. The following should be viewed in light of FIGS. 2 through 4. Clutch 100 includes axis of rotation AR, inner race 102, and wedge plate 104 located radially outward of race 102. Race 102 includes ramps 106 and 108. Each ramp 106 extends progressively radially inward in circumferential direction CD1 and extends distance 110 in circumferential direction CD1. Each ramp 108: is directly connected to a respective ramp 106 at a respective point P1; extends progressively radially inward in circumferential direction CD2, opposite circumferential direction CD1; and extends, in circumferential direction CD1, distance 112, less than distance 110.

For example: distance 114 from axis AR to radially outer surface 116 of each ramp 106 decreases moving in circumferential direction CD1; and distance 118 from axis AR to radially outer surface 120 of each ramp 108 decreases moving in circumferential direction CD2.

Wedge plate 104 includes ramps 122 and 124. Each ramp 122 extends progressively radially inward in circumferential direction CD1 and extends distance 126 in circumferential direction CD1. Each ramp 124: is directly connected to a respective ramp 122 at a respective point P2; extends progressively radially inward in circumferential direction CD2; and extends, in circumferential direction CD1, distance 128, less than distance 126.

For example: distance 130 from axis AR to radially inner surface 132 of each ramp 122 decreases moving in circumferential direction CD1; and distance 134 from axis AR to radially inner surface 136 of each ramp 124 decreases moving in circumferential direction CD2.

Ramps 106 are in contact with ramps 122. Ramps 108 are in contact with ramps 124. For example, ramp 106A is in contact with ramp 122A and ramp 108A is in contact with ramp 124A.

Each ramp 106 includes opposite circumferential ends 138 and 140. Distance 110 is from end 138 to end 140. Each ramp 108 includes circumferential end 142. Distance 112 is from end 140 to end 142. Each end 140 includes a radially innermost portion of a respective ramp 106. Each ramp 108 includes circumferential end 144 including a radially innermost portion of the ramp 108. Respective ends 140 and 144 are directly connected at respective points P1.

Each ramp 122 includes opposite circumferential ends 146 and 148. Distance 126 is from end 146 to end 148. Each ramp 124 includes circumferential end 150. Distance 128 is from end 148 to end 150. Each end 148 includes a radially innermost portion of a respective ramp 122. Each ramp 124 includes circumferential end 152 including a radially innermost portion of the ramp 124. Respective ends 148 and 152 are directly connected at respective points P2.

Inner race 102 includes radially outer circumference 154. Respective ramps 106 and 108 are directly connected at respective points P1 on radially outer circumference 154. Wedge plate 106 includes radially outer circumference 156. In an example embodiment, wedge plate 106 includes slots 158 extending radially inward from radially outer circumference 156. Line L1, orthogonal to axis of rotation AR, passes through a slot 158 and a point P1.

Race 102 includes circumferentially adjacent ramp pairs 160 and 162. Each ramp pair 160 includes a respective ramp 106 and a respective ramp 108. Each ramp pair 162 includes a respective ramp 106 and a respective ramp 108. Pairs 160 and 162 alternate in direction CD1. Wedge plate 106 includes radially inner circumference 164. In an example embodiment, plate 106 includes slots 166 extending radially outward from radially inner circumference 164. Line L2, orthogonal to axis of rotation AR, passes between a ramp pair 160 and a ramp pair 162 and through a slot 166.

In an example embodiment, wedge plate 106 includes circumferential ends 168 and 170 connecting radially inner circumference 164 and radially outer circumference 156. Ends 168 and 170 are separated by gap 172 in circumferential direction CD1. Thus, plate 106 is discontinuous in circumferential direction CD1.

In an example embodiment, wedge plate 104 includes circumferentially adjacent slot pairs 174 and 176. Each slot pair 174 includes respective circumferentially adjacent slots 158 and 166. Each slot pair 176 includes respective circumferentially adjacent slots 158 and 166. Pairs 174 and 176 alternate in direction CD1. In each slot pair 174, respective slots 158 and 166 are separated by distance 178 in circumferential direction CD1. Circumferentially adjacent slot pairs 174 and 176 are separated by distance 180 in circumferential direction CD1. In an example embodiment, distances 178 and 180 are different. In an example embodiment, distance 178 is less than distance 180. Stated otherwise: a slot 158 is separated, in circumferential direction CD1, by distance 178 from a slot 166 adjacent to the slot 158 circumferential direction CD1; and the slot 158 is separated, in circumferential direction CD2, by distance 180 from a slot 166 adjacent to the slot 158 circumferential direction CD2.

In an example embodiment, wedge clutch 100 includes outer race 182 and wedge plate 104 is frictionally engaged with race 182. For example, wedge plate 104 is biased so as to expand radially outward into contact with race 182. For relative rotation of inner race 102, with respect to outer race 182, in circumferential direction CD1, ramps 106 displace ramps 122 radially outward to non-rotatably connect inner race 102, wedge plate 104, and outer race 182. By non-rotatably connected components, we mean that: whenever one of the components rotates at a particular speed, all the components rotate at the particular speed; and relative rotation between the components is not possible. As inner race 102 rotates in direction CD1 with respect to race 182, the frictional contact of wedge plate 104 with race 182 causes relative rotation between inner race 102 and wedge plate 104 in direction CD1. Since ramps 106 extend radially outward in direction CD2 and ramps 122 extend radially inward in direction CD1, the relative rotation causes ramps 122 slide up ramps 106, pushing ramps 122 and wedge plate 104 radially outward.

The outward displacement of wedge plate 104 compressively engages ramps 106 with ramps 122 and outer circumference 156 of wedge plate 104 with race 182, non-rotatably connecting race 102, plate 104, and race 182. Ramps 108 slide along ramps 124 in direction CD1. However, since ramps 108 extend radially inward in direction CD2 and ramps 122 extend radially outward in direction CD1, ramps 124 slide down ramps 108, preventing compressive engagement of ramps 108 and 124.

For relative rotation of inner race 102, with respect to outer race 182, in circumferential direction CD2, ramps 108 are arranged to displace ramps 124 radially outward to non-rotatably connect inner race 102, wedge plate 104, and outer race 182. As inner race 102 rotates in direction CD2 with respect to race 182, the frictional contact of wedge plate 104 with outer race 182 causes relative rotation between inner race 102 and wedge plate 104 in direction CD2. Since ramps 108 extend radially outward in direction CD1 and ramps 124 extend radially inward in direction CD2, the relative rotation causes ramps 124 slide up ramps 108, pushing ramps 124 and wedge plate 104 radially outward. The outward displacement of wedge plate 104 compressively engages ramps 108 with ramps 124 and circumference 156 with race 182, non-rotatably connecting race 102, plate 104, and race 182. Ramps 106 slide along ramps 122 in direction CD2. However, since ramps 106 extend radially inward in direction CD1 and ramps 122 extend radially outward in direction CD2, ramps 122 slide down ramps 106, preventing compressive engagement of ramps 106 and 122.

In an example embodiment, inner race 102 includes spline teeth 184 arranged to non-rotatably engage with a shaft. It should be understood that inner race 102 can receive and transmit torque to outer race 182 via wedge plate 104, or outer race 182 can receive and transmit torque to inner race 102 via wedge plate 104.

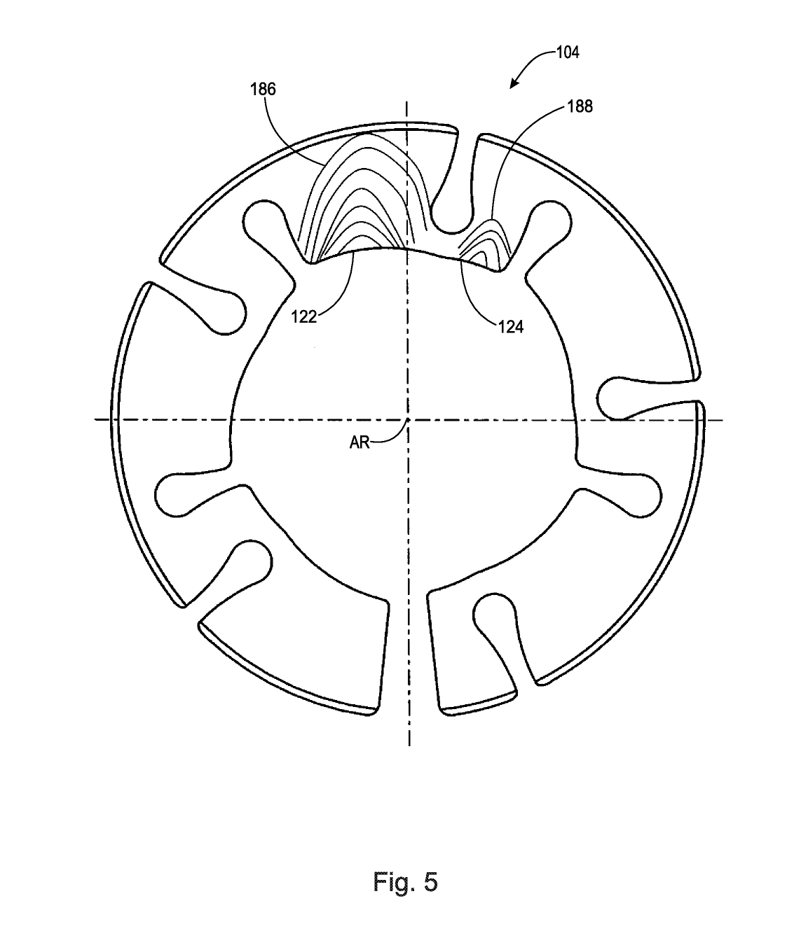

FIG. 5 is a front view of wedge plate 104 in FIG. 2, showing torque stresses. The torque bearing capacity of wedge plate 104 is related to the circumferential extents of ramps 122 and 124. In the example of FIGS. 2 through 5, the drive mode is associated with compressive engagement of ramps 122 with inner race 102 and rotation of inner race 102 in direction CD1, and the coast mode is associate with compressive engagement of ramps 124 with inner race 102 and the rotation of inner race 102 in direction CD2. Advantageously, distance 126 is greater than distance 128. That is, ramps 122 have greater respective circumferential extents than ramps 124. As a result, a greater portion of the material forming wedge plate 104 is available for torque loading in the drive mode than for torque loading in the coast mode. For example, stress 186 represents the maximum amount of stress wedge plate 104 withstands in the drive mode. Stress 188, considerably less than stress 186, represents the maximum amount of stress wedge plate 104 withstands in the coast mode. Stated otherwise, more material for plate 104 is available in the drive mode to accommodate torque stress.

Thus, without increasing the dimensions, such as radius 190, of wedge plate 104, the torque bearing capacity of clutch 100 for the drive mode is considerably increased from the torque bearing capacity that would be associated with equal distances 126 and 128.

It should be understood that in an example embodiment (not shown) the configuration of inner race 102 and wedge plate 104 is reversed. That is: each ramp 106 extends progressively radially inward in circumferential direction CD2; each ramp 108 extends progressively radially inward in circumferential direction CD1; each ramp 122 extends progressively radially inward in circumferential direction CD2; and each ramp 124 extends progressively radially inward in circumferential direction CD1. For the preceding example embodiment: drive mode is associated with relative rotation of inner race 102 in direction CD2 with respect to outer race 182; and coast mode is associated with relative rotation of inner race 102 in direction CD1 with respect to outer race 182.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A bi-direction wedge clutch, comprising:
an axis of rotation;
an inner race including:
a first ramp:
extending progressively radially inward in a first circumferential direction; and,
extending a distance in the first circumferential direction;
a second ramp:
directly connected to the first ramp;
extending progressively radially inward in a second circumferential direction, opposite the first circumferential direction; and,
extending, in the first circumferential direction, a distance less than the distance for the first ramp; and,
a wedge plate located radially outward of the inner race and including first and second ramps in contact with the first and second ramps, respectively, of the inner race.

2. The bi-direction wedge clutch of claim 1, wherein the first and second ramps of the inner race alternate in the first circumferential direction.

3. The bi-direction wedge clutch of claim 1, wherein:
the first ramp of the inner race includes first and second opposite circumferential ends;
the distance for the first ramp of the inner race is from the first circumferential end to the second circumferential end;
the second ramp of the inner race includes a circumferential end; and,
the distance for the second ramp of the inner race is from the second circumferential end of the first ramp to the second circumferential end of the second ramp.

4. The bi-direction wedge clutch of claim 1, wherein:
the first ramp of the inner race includes a circumferential end, the circumferential end including a radially innermost portion of the first ramp of the inner race;
the second ramp of the inner race includes a circumferential end, the circumferential end of the second ramp including a radially innermost portion of the second ramp of the inner race; and,
the circumferential end of the first ramp is directly connected to the circumferential end of the second ramp.

5. The bi-direction wedge clutch of claim 4, wherein:
the inner race includes a radially outer circumference;
the circumferential ends of the first and second ramps are directly connected at a point on the radially outer circumference of the inner race;
the wedge plate includes:
a radially outer circumference; and,
a slot extending radially inward from the radially outer circumference of the wedge plate; and,
a line orthogonal to the axis of rotation passes through the slot and the point.

6. The bi-direction wedge clutch of claim 1, wherein:
the first and second ramps of the inner race are a first pair of ramps;
the inner race includes a second pair of ramps circumferentially adjacent to the first pair of ramps, the second pair of ramps including:
a first ramp extending:
progressively radially inward in the first circumferential direction; and,
extending a distance in the first circumferential direction; and,
a second ramp:
directly connected to the first ramp for the second pair of ramps;
extending progressively radially inward in the second circumferential direction; and,
extending, in the first circumferential direction, a distance less than the distance for the first ramp for the second pair of ramps;
the wedge plate includes:
a radially inner circumference; and,
a slot extending radially outward from the radially inner circumference; and,
a line orthogonal to the axis of rotation passes between the first and second pairs of ramps and through the slot.

7. The bi-direction wedge clutch of claim 1, wherein:
the first ramp of the wedge plate extends:
progressively radially inward in the first circumferential direction; and,
a distance in the first circumferential direction; and,
the second ramp of the wedge plate:
is directly connected to the first ramp for the wedge plate;
extends progressively radially inward in the second circumferential direction; and,
extends, in the first circumferential direction, a distance less than the distance for the first ramp of the wedge plate.

8. The bi-direction wedge clutch of claim 1, wherein the wedge plate includes:
radially inner and outer circumferences; and,
first and second circumferential ends:
connecting the radially inner and outer circumferences of the wedge plate; and,
separated by a gap in the first circumferential direction.

9. The bi-direction wedge clutch of claim 1, further comprising:
an outer race located radially outward of the wedge plate, wherein:
for relative rotation of the inner race, with respect to the outer race, in the first circumferential direction, the first ramp of the inner race is arranged to displace the first ramp of the wedge plate radially outward to non-rotatably connect the inner race, the wedge plate, and the outer race; and,
for relative rotation of the inner race, with respect to the outer race, in the second circumferential direction, the second ramp of the inner race is arranged to displace the second ramp of the wedge plate radially outward to non-rotatably connect the inner race, the wedge plate, and the outer race.

10. The bi-direction wedge clutch of claim 1, wherein:
the wedge plate includes:
an inner circumference and an outer circumference;
a plurality of slots extending radially inward from the outer circumference; and,
a plurality of slots extending radially outward from the inner circumference;
a slot from the plurality of slots extending radially inward:
is separated, in the first circumferential direction, by a first distance from a slot from the plurality of slots extending radially outward and adjacent to the slot from the plurality of slots in the first circumferential direction; and,
is separated, in the second circumferential direction, by a second distance from a slot from the plurality of slots extending radially outward and adjacent to the slot from the plurality of slots in the second circumferential direction; and,
the second distance is greater than the first distance.

11. A bi-direction wedge clutch, comprising:
an axis of rotation;
a wedge plate including:
a first ramp:
extending progressively radially inward in a first circumferential direction; and,
extending a distance in the first circumferential direction;
a second ramp:
directly connected to the first ramp;
extending progressively radially inward in a second circumferential direction, opposite the first circumferential direction; and,
extending, in the first circumferential direction, a distance less than the distance for the first ramp; and,
an inner race located radially inward of the wedge plate and including first and second ramps in contact with the first ramp of the wedge plate and the second ramp of the wedge plate, respectively.

12. The bi-direction wedge clutch of claim 11, wherein the first and second ramps of the wedge plate alternate in the first circumferential direction.

13. The bi-direction wedge clutch of claim 11, wherein:
the first ramp of the wedge plate includes first and second opposite circumferential ends;
the distance for the first ramp of the wedge plate is from the first circumferential end to the second circumferential end;
the second ramp of the wedge plate includes a circumferential end; and,
the distance for the second ramp of the wedge plate is from the second circumferential end of the first ramp to the circumferential end of the second ramp.

14. The bi-direction wedge clutch of claim 11, wherein:
the first ramp of the wedge plate includes a circumferential end, the circumferential end including a radially innermost portion of the first ramp of the wedge plate;
the second ramp of the wedge plate includes a circumferential end, the circumferential end including a radially innermost portion of the second ramp of the wedge plate; and,
the circumferentially end of the first ramp is directly connected to the circumferential end of the second ramp.

15. The bi-direction wedge clutch of claim 14, wherein:
the wedge plate includes a radially inner circumference and a radially outer circumference;
the circumferential ends are directly connected at a point on the radially inner circumference;
the wedge plate includes a slot extending radially inward from the radially outer circumference; and,
a line orthogonal to the axis of rotation passes through the slot and the point.

16. The bi-direction wedge clutch of claim 11, wherein:
the first and second ramps of the wedge plate are a first pair of ramps;
the wedge plate includes a second pair of ramps circumferentially adjacent to the first pair of ramps, the second pair of ramps including:
a first ramp extending:
progressively radially inward in the first circumferential direction; and,
extending a distance in the first circumferential direction; and,
a second ramp:
directly connected to the first ramp for the second pair of ramps;
extending progressively radially inward in the second circumferential direction; and,
extending, in the first circumferential direction, a distance less than the distance for the first ramp for the second pair of ramps;
the wedge plate includes:
a radially inner circumference; and,
a slot extending radially outward from the radially inner circumference; and,
a line orthogonal to the axis of rotation passes between the first and second pairs of ramps and through the slot.

17. The bi-direction wedge clutch of claim 11, wherein:
the first ramp of the inner race extends:
progressively radially inward in the first circumferential direction; and,
extends a distance in the first circumferential direction; and,
the second ramp of the inner race:
is directly connected to the first ramp for the inner race;
extends progressively radially inward in the second circumferential direction; and,
extends, in the first circumferential direction, a distance less than the distance for the first ramp of the inner race.

18. The bi-direction wedge clutch of claim 11, further comprising:
an outer race located radially outward of the wedge plate, wherein:
for relative rotation of the inner race, with respect to the outer race, in the first circumferential direction, the first ramp of the inner race is arranged to displace the first ramp of the wedge plate radially outward to non-rotatably connect the inner race, the wedge plate, and the outer race; and,
for relative rotation of the inner race, with respect to the outer race, in the second circumferential direction, the second ramp of the inner race is arranged to displace the second ramp of the wedge plate radially outward to non-rotatably connect the inner race, the wedge plate, and the outer race.

19. A bi-direction wedge clutch, comprising:
an inner race including:
a first plurality of ramps, each ramp in the first plurality of ramps:
extending progressively radially inward in a first circumferential direction; and,
extending a distance in the first circumferential direction;
a second plurality of ramps alternating, in the first circumferential direction, with the first plurality of ramps, each ramp in the second plurality of ramps:
extending progressively radially inward in a second circumferential direction, opposite the first circumferential direction; and,
extending, in the first circumferential direction, a distance less than the distance for said each ramp in the first plurality of ramps; and,
a wedge plate located radially outward of the inner race and including:
a first plurality of ramps in contact with the first plurality of ramps of the wedge plate, each ramp in the first plurality of ramps of the wedge plate:
extending progressively radially inward in the first circumferential direction; and,
extending, in the first circumferential direction, a distance;
a second plurality of ramps in contact with the second plurality of ramps for the inner race, each ramp in the second plurality of ramps of the wedge plate:
extending progressively radially inward in the second circumferential direction; and,
extending, in the first circumferential direction, a distance less than the distance for said each ramp in the first plurality of ramps of the wedge plate.

20. The bi-direction wedge clutch of claim 19, further comprising:
an outer race located radially outward of the wedge plate, wherein:
for relative rotation of the inner race, with respect to the outer race, in the first circumferential direction, the first plurality of ramps of the inner race is arranged to displace the first plurality of ramps of the wedge plate radially outward to non-rotatably connect the inner race, the wedge plate, and the outer race; and,
for relative rotation of the inner race, with respect to the outer race, in the second circumferential direction, the second plurality of ramps of the inner race is arranged to displace the second plurality of ramps of the wedge plate radially outward to non-rotatably connect the inner race, the wedge plate, and the outer race.
